(19) United States
(12) Patent Application Publication
(10) Pub. No.: US 2012/0201299 A1
(43) Pub. Date: Aug. 9, 2012

(54) IMAGING APPARATUS, RECEIVING APPARATUS, VIDEO TRANSMISSION SYSTEM, AND VIDEO TRANSMISSION METHOD

(76) Inventors: Takehiko Sasaki, Kanagawa (JP); Masaaki Isozu, Tokyo (JP); Kazuhiro Watanabe, Tokyo (JP)

(21) Appl. No.: 13/362,560

(22) Filed: Jan. 31, 2012

(30) Foreign Application Priority Data
Feb. 3, 2011 (JP) 2011-022067

(51) Int. Cl. H04N 7/32

(52) U.S. Cl. 375/240.12; 375/E07.027; 375/E07.243

(57) ABSTRACT

An imaging apparatus includes: an encoded-data generating section configured to generate encoded data including a first picture that can be decoded without referring to other pictures and one or more second pictures that can be decoded referring to other pictures; a transmission-data generating section configured to combine the first picture of the encoded data and the one or more second pictures of encoded data immediately preceding the encoded data to generate transmission data; and a radio communication section configured to intermittently transmit, in a unit of the transmission data, a plurality of the transmission data included in a video stream.

### FIELD

The present disclosure relates to an imaging apparatus, a receiving apparatus, a video transmission system, and a video transmission method.

### BACKGROUND

In recent years, a video transmission system such as a monitoring system employing a battery-driven small camera is put to practical use. In the video transmission system, the camera transmits video data to a receiving apparatus such as a server through an access point and the server receives and processes the video data. The server performs analysis processing for the video data requested to have real-time properties such as object detection and moving object detection.

### SUMMARY

In the camera of such a video transmission system, since it is requested to steadily transmit video data to the receiving apparatus in order to secure the real-time properties of the analysis processing, a battery is constantly consumed for data transmission. Therefore, there is a demand for suppression of the battery consumption of the camera in realizing the video transmission system.

Therefore, it is desirable to provide an imaging apparatus, a receiving apparatus, a video transmission system, and a video transmission method that can suppress battery consumption during video transmission.

An embodiment of the present disclosure is directed to an imaging apparatus including: an encoded-data generating section configured to generate encoded data including a first picture that can be decoded without referring to other pictures and one or more second pictures that can be decoded referring to other pictures; a transmission-data generating section configured to combine the first picture of the encoded data and the one or more second pictures of encoded data immediately preceding the encoded data to generate transmission data; and a radio communication section configured to intermittently transmit, in a unit of the transmission data, a plurality of the transmission data included in a video stream.

The radio communication section has an operation mode including an active mode and a power save mode. The imaging apparatus may further include a communication control section configured to switch the operation mode to the power save mode after the transmission data is transmitted and switch the operation mode to the active mode before the next transmission data is transmitted.

The radio communication section may stop detection of a carrier wave in the power save mode.

The imaging apparatus may further include a power supply section configured to supply operation power to at least the radio communication section.

The transmission-data generating section may generate transmission data in which pictures are arranged in the order of the first picture of the encoded data and the one or more second pictures of encoded data immediately preceding the encoded data.

The transmission-data generating section may generate transmission data in which pictures are arranged in the order of the one or more second pictures of the encoded data and the first picture of encoded data immediately following the encoded data.

The radio communication section may intermittently transmit the plural transmission data in a unit of the transmission data by collectively transmitting, together with the first picture, the one or more second pictures included in the respective transmission data.

Another embodiment of the present disclosure is directed to a receiving apparatus including: a communication section configured to intermittently receive, in a unit of transmission data, a plurality of the transmission data included in a video stream, encoded data including a first picture that can be decoded without referring to other pictures and one or more second pictures that can be decoded referring to other pictures and the transmission data being generated by combining the first picture of the encoded data and the one or more second pictures of encoded data immediately preceding the encoded data; and an analysis processing section configured to subject at least the first picture included in the transmission data to analysis processing.

The receiving apparatus may further include a video-data generating section configured to combine decoded data of the first picture included in the transmission data and decoded data of the one or more second pictures included in transmission data immediately preceding the transmission data to generate video data.

Still another embodiment of the present disclosure is directed to a video transmission system including the imaging apparatus and the receiving apparatus.

Yet another embodiment of the present disclosure is directed to a video transmission method including: generating encoded data including a first picture that can be decoded without referring to other pictures and one or more second pictures that can be decoded referring to other pictures; combining the first picture of the encoded data and the one or more second pictures of encoded data immediately preceding the encoded data to generate transmission data; and intermittently transmitting, in a unit of the transmission data, a plurality of the transmission data included in a video stream.

Still yet another embodiment of the present disclosure is directed to a computer program for causing a computer to execute the video transmission method. The computer program may be provided using a computer-readable recording medium or may be provided via communication means or the like.

According to the embodiments of the present disclosure, it is possible to provide an imaging apparatus, a receiving apparatus, a video transmission system, and a video transmission method that can suppress battery consumption during video transmission.

### BRIEF DESCRIPTION OF THE DRAWINGS

FIG. 1 is a diagram of a video transmission system according to an embodiment of the present disclosure;

FIG. 2 is a block diagram of the configuration of a camera according to the embodiment of the present disclosure;

FIG. 3 is a block diagram of the configuration of a server according to the embodiment of the present disclosure;

FIG. 4 is a diagram of a configuration example of encoded data and transmission data;

FIG. 5 is a diagram of a configuration example of transmission data;

FIG. 6 is a flowchart for explaining the operation of the camera;

FIG. 7 is a diagram for explaining a video transmission method in the video transmission system according to the embodiment of the present disclosure;

FIG. 8 is a flowchart for explaining the operation of the server; and

FIG. 9 is a diagram for explaining a video transmission method in a general video transmission system.

### DETAILED DESCRIPTION

An embodiment of the present disclosure is explained in detail below with reference to the accompanying drawings.

In this specification and the drawings, components having substantially the same functional configurations are denoted by the same reference numerals and signs and redundant explanation of the components is omitted.

### 1. GENERAL VIDEO TRANSMISSION SYSTEM

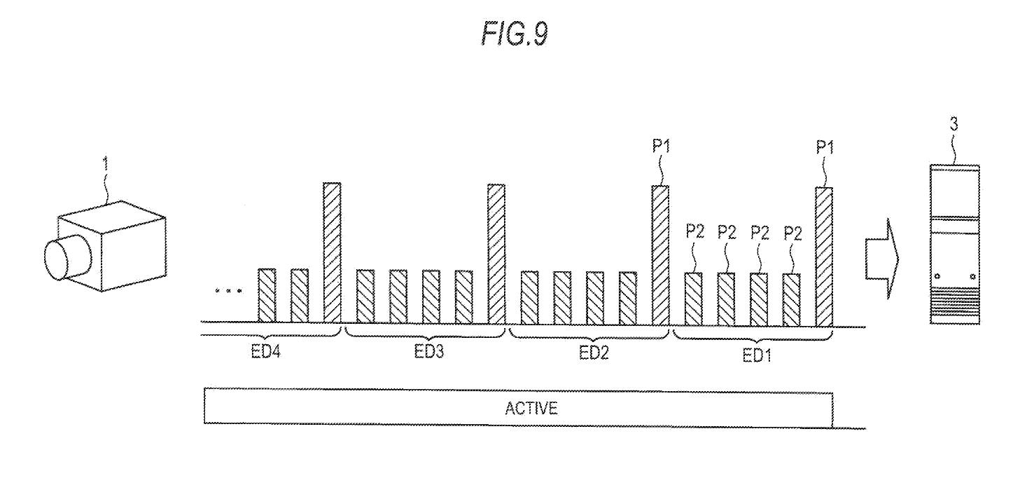

First, a video transmission method in a general video transmission system is explained with reference to FIG. 9.

FIG. 9 is a diagram for explaining the video transmission method in the general video transmission system. As shown in FIG. 9, in the video transmission system, a camera 1 transmits video data to a server 3 through an access point AP and a network NW not shown in the figure. The server 3 receives the video data and subjects the video data to analysis processing on a real time basis.

The camera 1 compression-encodes the video data using a system such as MPEG (Moving Picture Experts Group) 2 or H.264|AVC (ITU-T recommendation MPEG-4 Part 10: Advanced Video Coding). The video data is compression-encoded as a picture that can be independently decoded (a first picture P1) and a picture (a second picture P2) that is a difference from the picture. The picture means an image. One picture is equivalent to one image. The compression encoding is performed by inter-frame encoding employing motion compensation (predictive encoding) in conjunction with intra-frame encoding employing orthogonal transform or the like.

The first picture P1 that can be independently decoded is an IDR (Instantaneous Decoding Refresh) picture, an I (Intra-decoded) picture, or the like that is encoded by intra-frame encoding. The first picture P1 can be decoded without referring to other pictures. The second picture P2 that may be unable to be independently decoded is a P (Predictive-coded) picture, a B (Bi-Directionally predictive-coded) picture, or the like that is encoded by inter-frame encoding. The second picture P2 may be unable to be decoded without referring to other pictures.

The camera 1 compression-encodes video data and transmits encoded data ED (a general term for encoded data). In FIG. 9, encoded data ED1, ED2, ED3, ED4, and the like are sequentially transmitted. The encoded data ED includes the first picture P1 and one or more second pictures P2 that are differences from the first picture P1. In the encoded data ED, the one or more second pictures P2 are arranged following the first picture P1. The server 3 receives the encoded data ED, preferentially extracts the first picture P1, decodes the extracted picture, and subjects the extracted picture to analysis processing on a real time basis.

Therefore, the camera 1 is requested to periodically transmit the first picture P1 to the server 3 in order to secure real-time properties of the analysis processing. Every time the first picture P1 or the second picture P2 is generated, the generated picture is successively transmitted. Therefore, a battery of the camera 1 is constantly consumed for data transmission over a transmission period of a video stream including plural encoded data ED.

### 2. CONFIGURATION OF A VIDEO TRANSMISSION SYSTEM ACCORDING TO AN EMBODIMENT OF THE PRESENT DISCLOSURE

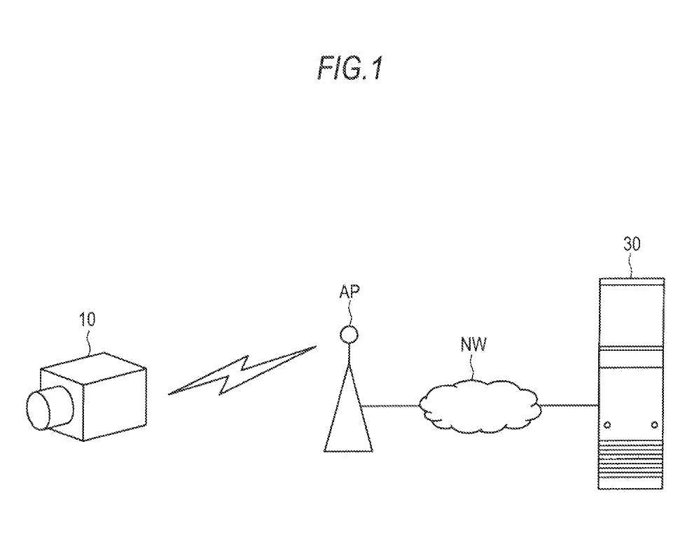

The configuration of a video transmission system according to an embodiment of the present disclosure is explained with reference to FIGS. 1 to 3.

FIG. 1 is a diagram of the video transmission system according to the embodiment of the present disclosure. As shown in FIG. 1, the video transmission system includes a camera 10, a server 30, an access point AP, and a network NW. The camera 10 is a battery-driven small imaging apparatus and is connected to the access point AP. The server 30 is an information processing apparatus that performs video analysis processing requested to have real-time properties such as object detection and moving object detection. The server 30 is connected to the network NW by wire or radio. The access point AP is a bridge, a router, or the like for radio communication. The access point AP connects the camera 10 and the network NW.

The camera 10 transmits video data to the access point AP. The access point AP performs buffering and transmission and reception of the video data between the access point AP and the camera 10. Similarly, the access point AP performs buffering and transmission and reception of the video data between the access point AP and the server 30 through the network NW. The server 30 receives the video data and subjects the video data to the analysis processing. The camera 10 may be connected to other servers through the access point AP or other access points. The server 30 may transmit the video data, a result of the analysis processing, and the like to a not-shown user terminal and the like.

### [2-1. Configuration of the Camera]

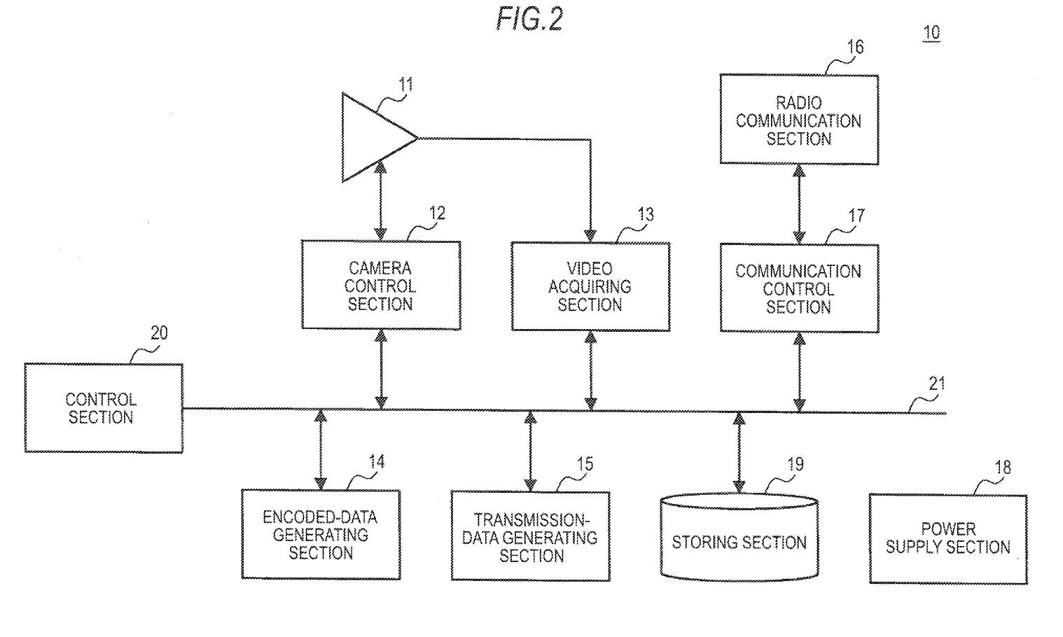

FIG. 2 is a block diagram of the configuration of the camera 10 according to the embodiment of the present disclosure. As shown in FIG. 2, the camera 10 includes an optical system 11, a camera control section 12, a video acquiring section 13, an encoded-data generating section 14, a transmission-data generating section 15, a radio communication section 16, a communication control section 17, a power supply section 18, a storing section 19, and a control section 20.

The optical system 11 includes a lens system, an aperture and focus adjusting mechanism, and a zoom and shutter mechanism. The optical system 11 leads light from a subject to the video acquiring section 13. The camera control section 12 controls the optical system 11 on the basis of a control signal supplied from the control section 20. The control signal is generated by the control section 20 on the basis of information of an imaging signal output from an imaging device explained later.

The video acquiring section 13 includes an imaging device, an imaging-signal processing section, and a video-signal processing section. The imaging device includes a CCD (Charge Coupled Device). The imaging device converts light led from the optical system 11 into an electric signal, subjects the electric signal to signal processing, and outputs the electric signal as an imaging signal. The imaging-signal processing section includes a CDS (Correlated Double Sampling) circuit, an AGC (Auto Gain Control) circuit, and an ADC (Analog Digital Converter) circuit and the like. The imaging-signal processing section subjects the imaging signal supplied from the imaging device to signal processing and outputs the imaging signal as a digital signal. The video-signal processing section includes a γ correction circuit and a white balance correction circuit. The video-signal processing section subjects the digital signal supplied from the imaging-signal processing section to signal processing and outputs the digital signal as video data.

The encoded-data generating section 14 includes a video encoder and compression-encodes the video data supplied from the video acquiring section 13 and generates the encoded data ED. The video data is compression-encoded using a system such as MPEG2 or H.264|AVC. The compression encoding is performed by inter-frame encoding employing motion compensation (predictive encoding) in conjunction with intra-frame encoding employing orthogonal transform or the like. The encoded data ED includes the first picture P1 that can be decoded without referring to other pictures and the second picture P2 that may be unable to be decoded without referring to other pictures. The first picture P1 is a picture subjected to the intra-frame encoding. The second picture P2 is a picture subjected to the inter-frame encoding as a difference from the first picture P1. The encoded data ED includes the first picture P1 and one or more second pictures P2 arranged following the first picture P1.

The transmission-data generating section 15 includes a data processing device and divides the first picture P1 and the second pictures P2 included in the encoded data ED supplied from the encoded-data generating section 14 and generates transmission data TD. The transmission data TD (a general term for transmission data) is basically data obtained by combining the first picture P1 of certain encoded data ED and the one or more second pictures P2 of encoded data ED immediately preceding the encoded data ED.

The radio communication section 16 includes a transmission and reception circuit and transmits and receives data such as the transmission data TD to and from the access point AP. The radio communication section 16 intermittently transmits, in a unit of the transmission data TD, plural transmission data TD included in a video stream. The intermittent transmission is performed by collectively transmitting, together with the first picture P1, the one or more second pictures P2 included in the transmission data TD. The radio communication section 16 operates in an operation mode such as an active mode or a power save mode. In the active mode, electric power is constantly supplied from the power supply section 18 to the transmission and reception circuit. In the power save mode, electric power is intermittently supplied according to necessity of the electric power.

The communication control section 17 controls the operation of the radio communication section 16 on the basis of a control signal supplied from the control section 20. The communication control section 17 switches the operation mode to the power save mode immediately after the transmission data TD is transmitted and switches the operation mode to the active mode immediately before the next transmission data TD is transmitted.

The power supply section 18 includes a chargeable or unchargeable battery and supplies operation power to the sections of the camera 10 including the radio communication section 16. The power supply section 18 controls the power supply to the radio communication section 16 on the basis of a control signal supplied from the control section 20. The power supply section 18 is connected to the control section 20 that controls the sections, which are supply destinations of the operation power, and the power supply sections 18 and the communication control section 17.

The storing section 19 includes a memory or a hard disk and stores video data, the encoded data ED, the transmission data TD, and the like. The control section 20 includes a CPU, a ROM, and a RAM or the like performs arithmetic operation and control necessary for the operation of the camera 10. The control section 20 reads out a computer program stored in the ROM or the like, expands the computer program on the RAM, and executes the computer program to control the operation of the camera 10. The control section 20 is connected to the camera control section 12, the video acquiring section 13, the encoded-data generating section 14, the transmission-data generating section 15, the communication control section 17, and the storing section 19 through a bus 21.

### [2-2. Configuration of the Server]

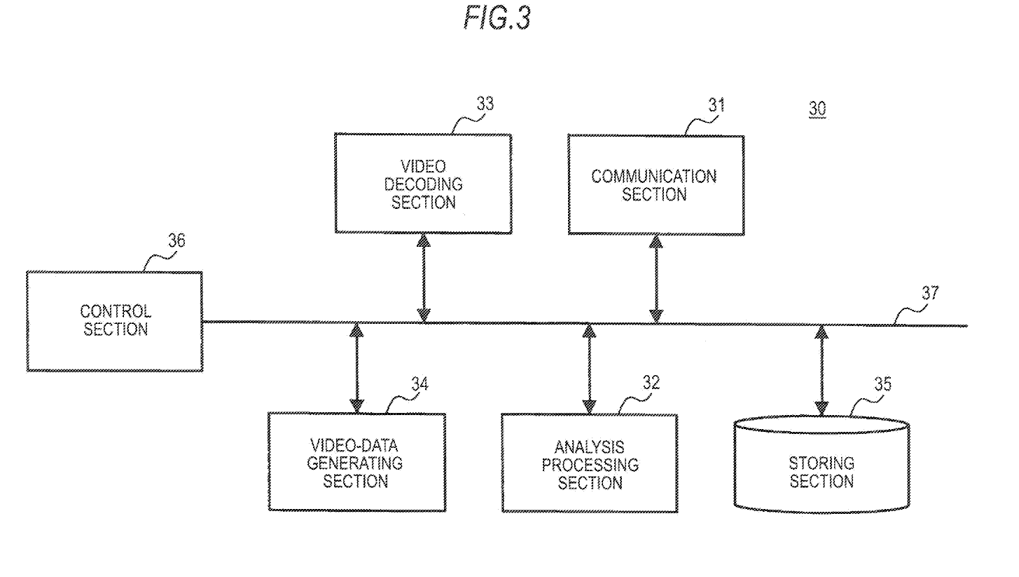

FIG. 3 is a block diagram of the configuration of the server 30 according to the embodiment of the present disclosure. As shown in FIG. 3, the server 30 includes a communication section 31, an analysis processing section 32, a video decoding section 33, a video-data generating section 34, and a storing section 35, and a control section 36.

The communication section 31 includes a transmission and reception circuit and transmits and receives data such as the transmission data TD to and from the access point AP through the network NW. The communication section 31 may transmit a video stream and a result of analysis processing to the not-shown user terminal and the like through the network NW or other networks.

The analysis processing section 32 includes a data processing device and performs, using the transmission data TD, analysis processing requested to have real-time properties such as object detection and moving object detection. For the analysis processing, the first picture P1 extracted from the transmission data TD and decoded is preferentially used. The first picture P1 sufficiently includes data of one picture unlike the second pictures P2 that are differences from other pictures. Therefore, the first picture P1 is preferentially used for the analysis processing. However, the one or more second pictures P2 may be used for the analysis processing together with the first picture P1.

The video decoding section 33 includes a video decoder and decompression-decodes a picture included in the transmission data TD and outputs decoded data. The decompression decoding is performed according to the intra-frame encoding and the inter-frame encoding.

The video-data generating section 34 includes a data processing device and generates video data from the transmission data TD. As explained above, the transmission data TD is basically data obtained by combining the first picture P1 of certain encoded data ED and the one or more second pictures P2 of encoded data ED immediately preceding the encoded data ED. Therefore, the video data is generated by combining decoded data of the first picture P1 included in the transmission data TD and decoded data of the one or more second pictures P2 included in transmission data TD following the transmission data TD.

The storing section 35 includes a memory or a hard disk and stores the transmission data TD, the encoded data ED, the decoded data, the video data, and the like. The control section 36 includes a CPU, a ROM, and a RAM and performs arithmetic operation and control necessary for the operation of the server 30. The control section 36 reads out a computer program stored in the ROM or the like, expands the computer program on the RAM, and executes the computer program to control the operation of the server 30. The control section 36 is connected to the sections of the server 30 through the bus 21.

### 3. ENCODED DATA ED AND TRANSMISSION DATA TD

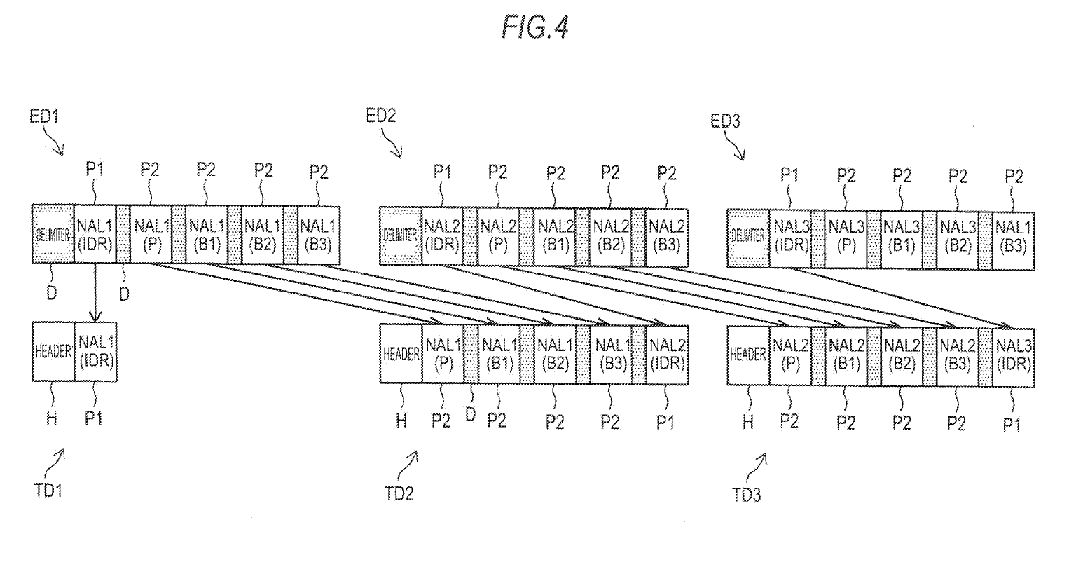

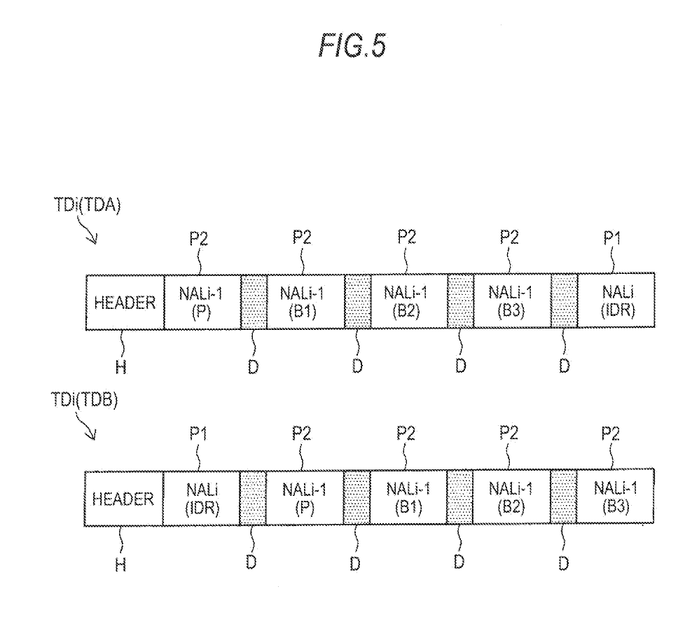

The encoded data ED and the transmission data TD are explained with reference to FIGS. 4 and 5.

FIG. 4 is a diagram of a configuration example of the encoded data ED and the transmission data TD. In the example shown in FIG. 4, encoded data ED1, ED2, ED3, and the like included in a video stream include plural network NW abstract layer (NAL) units. Specifically, the encoded data ED includes units of NAL(IDR), NAL(P), NAL(B1), NAL(B2), and NAL(B3).

The NAL units respectively include data of an IDR picture (IDR), a P picture (P), and B pictures (B1 to B3). A delimiter D indicating a boundary of the NAL unit is arranged at the head of the encoded data ED and between the NAL units. The IDR picture is the first picture P1 that can be independently decoded. The P picture and the B pictures are the second pictures P2 that may be unable to be independently decoded.

The transmission data TD is generated by combining the first picture P1 of the encoded data ED and the one or more second pictures P2 of encoded data ED immediately preceding the encoded data ED. Specifically, transmission data TD1 is generated from the first picture P1 of the encoded data ED1. Transmission data TD2 is generated from the one or more second pictures P2 of the encoded data ED1 and the first picture P1 of the encoded data ED2. Transmission data TD3 is generated from the one or more second pictures P2 of the encoded data ED2 and the first picture P1 of the encoded data ED3. A peculiar header H indicating the transmission data TD is arranged at the head of the transmission data TD. The delimiter D is arranged between the NAL units.

FIG. 5 is a diagram of a configuration example of the transmission data TD. In FIG. 5, transmission data TDi(TDA) generated by arranging pictures in the order of the one or more second pictures P2 of encoded data EDi−1 and the first picture P1 of encoded data EDi immediately following the encoded data EDi−1 is shown to correspond to FIG. 4. Here, i is a natural number equal to or larger than 2. Conversely, as indicated by transmission data TDi(TDB), transmission data may be generated by arranging pictures in the order of the first picture P1 of the encoded data EDi and the one or more second pictures P2 of encoded data EDi−1 immediately preceding the encoded data EDi.

FIGS. 4 and 5 do not limit the configurations of the encoded data ED and the transmission data TD. For example, the number of NAL units and types of pictures are arbitrarily specified among the encoded data ED and among the transmission data TD. It goes without saying that the encoded data ED and the transmission data TD may include an NAL unit of an I picture as the first picture P1 instead of the IDR picture or together with the IDR picture.

### 4. OPERATION OF THE VIDEO TRANSMISSION SYSTEM ACCORDING TO THE EMBODIMENT OF THE PRESENT DISCLOSURE

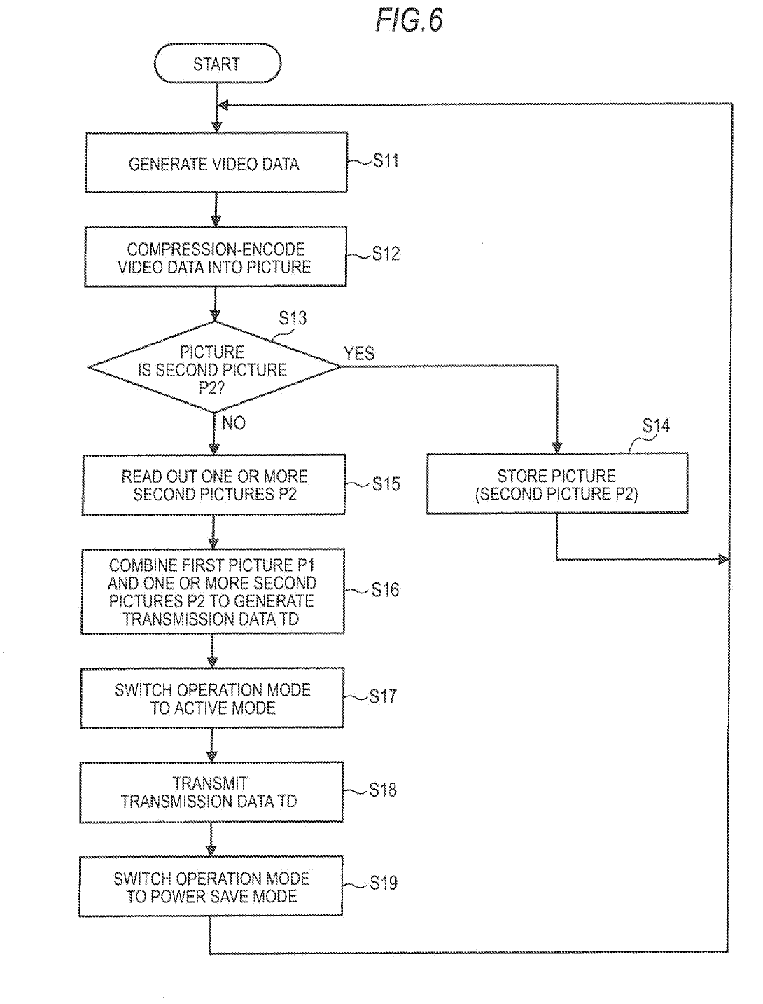

The operation of the camera 10 and the server 30 is explained with reference to FIGS. 6 to 8.

FIG. 6 is a flowchart for explaining the operation of the camera 10. As shown in FIG. 6, the video acquiring section 13 generates video data corresponding to light led from the optical system 11 (step S11) and supplies the video data to the encoded-data generating section 14. The encoded-data generating section 14 compression-encodes the video data supplied from the video acquiring section 13 into a picture (step S12) and supplies the picture to the control section 20. The compression encoding is performed by the intra-frame encoding and the inter-frame encoding (predictive encoding). The video data is compression-encoded for each encoded data ED in the order of the first picture P1 and the one or more second pictures P2 following the first picture P1.

When the picture included in the encoded data ED is supplied, the control section 20 determines whether the picture is the second picture P2 (step S13). When the picture is the second picture P2 that may be unable to be independently decoded (“Yes” in step S13), the control section 20 stores the picture (the second picture P2) in the storing section 19 (step S14). The control section 20 stores the one or more second pictures P2 to make it possible to specify supply order of the second pictures P2. The processing in steps S11 to S14 is repeated until the supply of the first picture P1 is confirmed.

On the other hand, when the picture is the first picture P1 that can be independently decoded (“No” in step S13), processing in step S15 and subsequent steps is executed. The control section 20 reads out the one or more second pictures P2 from the storing section 19 (step S15) and supplies the second pictures P2 to the transmission-data generating section 15 together with the picture (the first picture P1). The read-out second pictures P2 are managed not to be readout again when other encoded data ED is processed.

The transmission-data generating section 15 combines the first picture P1 of the encoded data EDi and the one or more second pictures P2 of the encoded data EDi−1 to generate transmission data TDi (step S16) and supplies the transmission data TDi to the control section 20. Here, i is a natural number equal to or larger than 2. The transmission data TD1 does not include the second picture P2 and includes the first picture P1 of the encoded data ED1. When the transmission data TDA shown in FIG. 5 is generated, pictures are arranged in the order of the one or more second pictures P2 of the encoded data EDi−1 and the first picture P1 of the encoded data EDi. When the transmission data TDB shown in FIG. 5 is generated, pictures are arranged in the order of the first picture P1 of the encoded data EDi and the one or more second pictures P2 of the encoded data EDi−1.

The control section 20 transfers the transmission data TD to the radio communication section 16 and outputs a control signal for switching the operation mode of the radio communication section 16 to the active mode to the communication control section 17. The communication control section 17 outputs a control signal for starting power supply to the radio communication section 16 to the power supply section 18. The radio communication section 16 switches the operation mode from the power save mode to the active mode (step S17) and transmits the transmission data TD (step S18). The radio communication section 16 collectively transmits, together with the first picture P1, the one or more second pictures P2 included in the transmission data TD. The processing in steps S11 to S16 may be performed during the transmission of the transmission data TD.

When the transmission of the transmission data TD ends, the control section 20 outputs a control signal for switching the operation mode to the power save mode to the communication control section 17. The communication control section 17 outputs a control signal for ending the power supply to the radio communication section 16 to the power supply section 18. The radio communication section 16 switches the operation mode from the active mode to the power save mode (step S19).

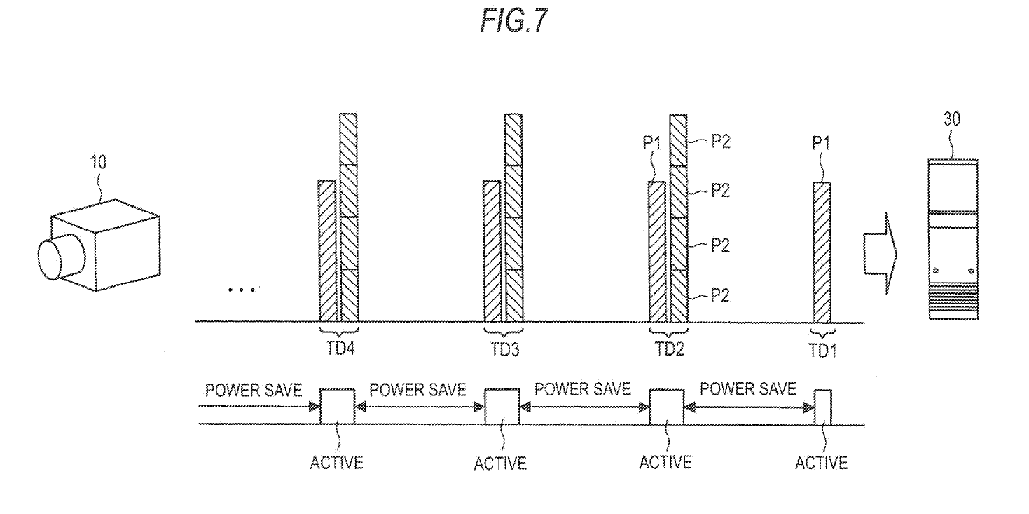

FIG. 7 is a diagram for explaining a video transmission method in the video transmission system according to the embodiment of the present disclosure. As shown in FIG. 7, the camera 10 intermittently transmits, in a unit of the transmission data TD, transmission data TD1, TD2, TD3, TD4, and the like included in a video stream in the order explained above. The one or more second pictures P2 included in each of the transmission data TD are collectively transmitted together with the first picture P1. The camera 10 shifts to the power save mode immediately after the transmission data TD is transmitted and returns to the active mode immediately before the next transmission data TD is transmitted.

In the general video transmission system explained with reference to FIG. 9, a generated picture is successively transmitted every time the first picture P1 or the second picture P2 is generated. Therefore, the battery of the camera is typically consumed for data transmission over a transmission period of a video stream including plural encoded data ED.

On the other hand, the video transmission system according to the embodiment of the present disclosure converts a picture into blocks of the transmission data TD and intermittently transmits the transmission data TD instead of successively transmitting the picture. Consequently, in a period in which data is not transmitted, it is possible to shift the radio communication section 16 to the power save mode such as PSM (Power-Saving Mode) specified in IEEE802.11. In the power save mode, since detection of a carrier wave is not performed, it is possible to minimize battery consumption for detection of a carrier wave and frame reception.

Further, since a picture is converted into blocks of the transmission data TD and transmitted, an aggregation effect specified in IEEE802.11n is obtained. Therefore, it is possible to suppress battery consumption by reducing the number of times of processing in carrier sense multiple access/collision avoidance (CSMA/CA) carried out every time data transmission is performed in the general video transmission method.

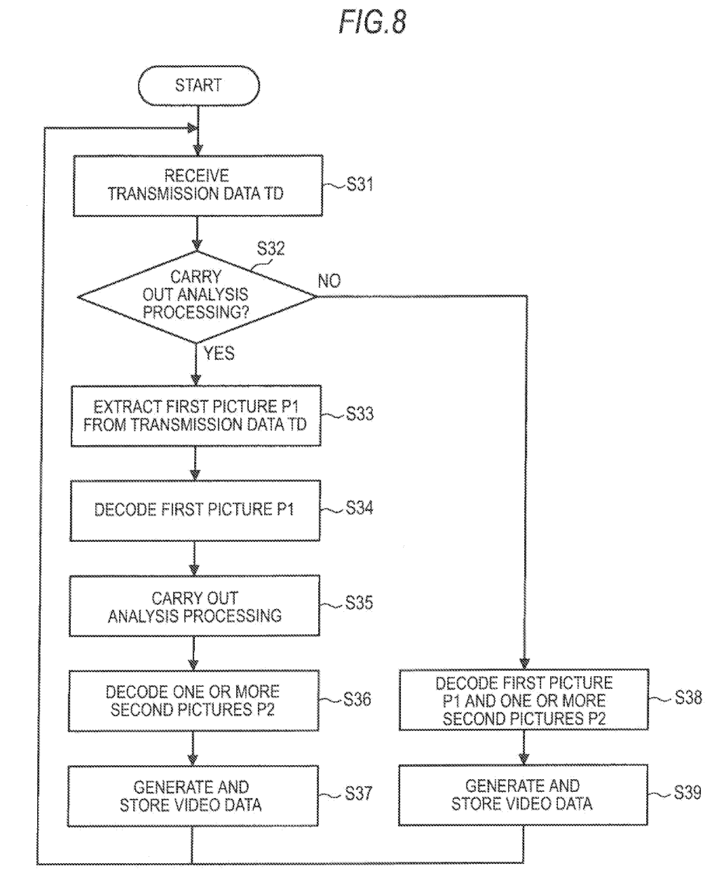

FIG. 8 is a flowchart for explaining the operation of the server 30. As shown in FIG. 8, the communication section 31 receives the transmission data TD (step S31) and supplies the transmission data TD to the control section 36. The control section 36 determines whether video data is subjected to the analysis processing (step S32).

When the video data is subjected to the analysis processing (“Yes” in step S32), the control section 36 extracts the first picture P1 from the transmission data TD (step S33) and supplies the first picture P1 to the video decoding section 33. The video decoding section 33 decodes the first picture P1 (step S34) and supplies decoded data to the analysis processing section 32. The analysis processing section 32 applies the analysis processing such as object detection or moving object detection to the decoded data (step S35) and outputs a processing result. The processing result may be transmitted to an external apparatus through the network NW or may be stored in the storing section 35 or the like. The video decoding section 33 further decodes the one or more second pictures P2 (step S36) and supplies decoded data to the video-data generating section 34. The video-data generating section 34 generates video data from the decoded data and stores the video data in the storing section 35 (step S37).

The video-data generating section 34 combines the decoded data of the first picture P1 included in the transmission data TDi and the decoded data of the one or more second pictures P2 included in transmission data TDi+1 to generate video data corresponding to the encoded data EDi. Here, i is a natural number equal to or lager than 1.

On the other hand, when the video data is not subjected to the analysis processing (“No” in step S32), the control section 36 supplies the transmission data TD to the video decoding section 33. The video decoding section 33 decodes the first picture P1 and the one or more second pictures P2 (step S38) and supplies decoded data to the video-data generating section 34. The video-data generating section 34 generates video data from the decoded data and stores the video data in the storing section 35 (step S39).

The control section 36 may transmit the video data and a result of the analysis processing to the user terminal or the like. In this case, the control section 36 reads out the video data and the result of the analysis processing from the storing section 35 and transmits the read-out data to the user terminal or the like through the communication section 31 according to an instruction from the user terminal or the like.

The video transmission system according to the embodiment of the present disclosure converts a picture into blocks of the transmission data TD and intermittently receives the transmission data TD instead of successively receiving the picture. However, as in the general video transmission method, the first picture P1 preferentially used for the video analysis processing is received at timing close to actual time.

In particular, if the transmission data TD (the transmission data TDB shown in FIG. 5, etc.) generated by arranging pictures in the order of the first picture P1 of the encoded data ED and the one or more second pictures P2 of encoded data ED immediately preceding the encoded data ED is received, it is possible to easily detect the first picture P1 used for the video analysis processing. On the other hand, if the transmission data TD (the transmission data TDA shown in FIG. 5, etc.) generated by arranging pictures in the order of the one or more second pictures P2 of the encoded data ED and the first picture P1 of encoded data ED immediately following the encoded data ED is received, since video data is stored according to the order of pictures in a video stream, it is possible to easily reproduce the video stream.

### 5. CONCLUSION

As explained above, the video transmission system according to the embodiment of the present disclosure converts a picture into blocks of the transmission data TD and intermittently transmits the transmission data TD instead of successively transmitting the picture. Therefore, it is possible to shift a radio communication device (the radio communication section 16, etc.) to the power saving mode in a period in which data is not transmitted. Consequently, compared with the video transmission method in the general video transmission system, it is possible to minimize battery consumption during video transmission.

The embodiment of the present disclosure is explained in detail above with reference to the accompanying drawings. However, the present disclosure is not limited to such an embodiment. It is evident that those having ordinary knowledge in the technical field to which the present disclosure belongs can easily arrive at various modifications and alterations without departing from the technical idea described in the appended claims. It is understood that these modifications and alterations also naturally belong to the technical scope of the present disclosure.

The present disclosure contains subject matter related to that disclosed in Japanese Priority Patent Application JP 2011-022067 filed in the Japan Patent Office on Feb. 3, 2011, the entire content of which is hereby incorporated by reference.

What is claimed is:

1. An imaging apparatus comprising:
an encoded-data generating section configured to generate encoded data including a first picture that can be decoded without referring to other pictures and one or more second pictures that can be decoded referring to other pictures;
a transmission-data generating section configured to combine the first picture of the encoded data and the one or more second'pictures of encoded data immediately preceding the encoded data to generate transmission data; and
a radio communication section configured to intermittently transmit, in a unit of the transmission data, a plurality of the transmission data included in a video stream.

2. The imaging apparatus according to claim 1, wherein
the radio communication section has an operation mode including an active mode and a power save mode, and
the imaging apparatus further comprises a communication control section configured to switch the operation mode to the power save mode after the transmission data is transmitted and switch the operation mode to the active mode before next transmission data is transmitted.

3. The imaging apparatus according to claim 2, wherein the radio communication section stops detection of a carrier wave in the power save mode.

4. The imaging apparatus according to claim 1, further comprising a power supply section configured to supply operation power to at least the radio communication section.

5. The imaging apparatus according to claim 1, wherein the transmission-data generating section generates transmission data in which pictures are arranged in order of the first picture of the encoded data and the one or more second pictures of encoded data immediately preceding the encoded data.

6. The imaging apparatus according to claim 1, wherein the transmission-data generating section generates transmission data in which pictures are arranged in order of the one or more second pictures of the encoded data and the first picture of encoded data immediately following the encoded data.

7. The imaging apparatus according to claim 1, wherein the radio communication section intermittently transmits the plural transmission data in a unit of the transmission data by collectively transmitting, together with the first picture, the one or more second pictures included in the respective transmission data.

8. A receiving apparatus comprising:
a communication section configured to intermittently receive, in a unit of transmission data, a plurality of the transmission data included in a video stream, encoded data including a first picture that can be decoded without referring to other pictures and one or more second pictures that can be decoded referring to other pictures and the transmission data being generated by combining the first picture of the encoded data and the one or more second pictures of encoded data immediately preceding the encoded data; and
an analysis processing section configured to subject at least the first picture included in the transmission data to analysis processing.

9. The receiving apparatus according to claim 8, further comprising a video-data generating section configured to combine decoded data of the first picture included in the transmission data and decoded data of the one or more second pictures included in transmission data immediately preceding the transmission data to generate video data.

10. A video transmission system comprising:
an imaging apparatus including
an encoded-data generating section configured to generate encoded data including a first picture that can be decoded without referring to other pictures and one or more second pictures that can be decoded referring to other pictures,
a transmission-data generating section configured to combine the first picture of the encoded data and the one or more second pictures of encoded data immediately preceding the encoded data to generate transmission data, and
a radio communication section configured to intermittently transmit, in a unit of the transmission data, a plurality of the transmission data included in a video stream; and
a receiving apparatus including
a communication section configured to intermittently receive the plural transmission data, and
an analysis processing section configured to subject at least the first picture included in the transmission data to analysis processing.

11. A video transmission method comprising:
generating encoded data including a first picture that can be decoded without referring to other pictures and one or more second pictures that can be decoded referring to other pictures;
combining the first picture of the encoded data and the one or more second pictures of encoded data immediately preceding the encoded data to generate transmission data; and
intermittently transmitting, in a unit of the transmission data, a plurality of the transmission data included in a video stream.
